(19) United States
(12) Patent Application Publication
(10) Pub. No.: US 2026/0120954 A1
(43) Pub. Date: Apr. 30, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Dokyeong Lee, Suwon-si (KR); Bonggyu Choi, Suwon-si (KR); Kwang Dong Seong, Suwon-si (KR); Sunho Yoon, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/188,789

(22) Filed: Apr. 24, 2025

(30) Foreign Application Priority Data
Oct. 25, 2024 (KR) 10-2024-0147814

(51) Int. Cl. H01G 4/232; H01G 4/30

(52) U.S. Cl. CPC H01G 4/2325; H01G 4/30

(57) ABSTRACT

Disclosed are a multilayer ceramic capacitor and a method of manufacturing the same, the multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the capacitor body includes an active region in which the dielectric layers and the internal electrode layers are alternately disposed, and a cover region in which the dielectric layers are disposed on the upper and lower surfaces of the active region in a stacking direction, the external electrode includes an inner layer disposed on a surface of the active region and connected to the internal electrode layer, and an outer layer covering the inner layer, the inner layer includes a conductive metal and glass, and an area occupied by the glass is greater than about 0% and less than or equal to about 6% of a total area of the inner layer.

### CROSS-REFERENCE TO RELATED APPLICATION

This application claims priority to and the benefit of Korean Patent Application No. 10-2024-0147814 filed in the Korean Intellectual Property Office on Oct. 25, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the miniaturization and layer thinning of MLCCs, not only has the micronization of metal particles used in electrodes become important, but also, due to the high reliability of automotive MLCCs, improving the contact between internal and external electrodes is becoming crucial.

However, as the metal particles used become smaller, the cost per particle increases due to the difficulty of synthesis, and the content of other polymers required for dispersion and adhesion of the paste, such as dispersants and binders, relatively increases, which has the side effect of causing this. As the content of other polymers increases, the metal solids content becomes relatively low, which changes the viscosity and rheological properties, affecting the printing characteristics. Therefore, metal electrodes using pastes with dispersed metal particles have these limitations.

### SUMMARY

Some embodiments of the present disclosure provide a multilayer ceramic capacitor having improved connectivity between internal electrode layers and external electrodes, thereby exhibiting superior capacitance characteristics, electrical characteristics, and moisture resistance reliability.

Another embodiments of the present disclosure provide a method of manufacturing a multilayer ceramic capacitor.

Some embodiments of the present disclosure provide a multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the capacitor body includes an active region in which the dielectric layers and the internal electrode layers are alternately disposed, and a cover region in which the dielectric layers are disposed on the upper and lower surfaces of the active region in a stacking direction, the external electrode includes an inner layer disposed on a surface of the active region and connected to the internal electrode layer, and an outer layer covering the inner layer, the inner layer includes a conductive metal and glass, and an area occupied by the glass is greater than about 0% and less than or equal to about 6% of a total area of the inner layer.

The glass of the inner layer may be included in an amount of greater than about 0 wt % and less than or equal to about 5 wt % based on a total amount of the inner layer.

The conductive metal of the inner layer may be included in an amount of greater than about 95 wt % and less than about 100 wt % based on a total amount of the inner layer.

The conductive metal of the inner layer may include at least one selected from the group consisting of copper (Cu), nickel (Ni), silver (Ag), palladium (Pd), gold (Au), platinum (Pt), tin (Sn), tungsten (W), titanium (Ti), lead (Pb), and an alloy thereof.

The conductive metal of the inner layer may include copper (Cu) and nickel (Ni).

The glass of the inner layer may include at least one selected from the group consisting of aluminum oxide (Al₂O₃), silicon dioxide (SiO₂), lithium oxide (Li₂O), sodium oxide (Na₂O), iron (III) oxide (Fe₂O₃), zinc oxide (ZnO), barium oxide (BaO), calcium oxide (CaO), boron trioxide (B₂O₃), and tin (IV) oxide (SnO₂).

The inner layer may extend into an interior of the capacitor body and be connected to the internal electrode layer.

A Cu—Ni alloy may be included at the interface between the inner layer of the external electrode and the internal electrode layer.

The glass of the inner layer may be present on a surface of the dielectric layer of the active region.

A thickness of the inner layer may be about 1 μm to about 5 μm.

A grain size of the conductive metal of the inner layer may be about 0.5 μm to about 1 μm.

The outer layer may include a conductive metal and glass, and the conductive metal of the outer layer may be the same as or different from the conductive metal of the inner layer, and the glass of the outer layer may be the same as or different from the glass of the inner layer.

The outer layer may include about 70 wt % to about 90 wt % of the conductive metal and about 10 wt % to about 30 wt % of the glass.

The internal electrode layer may include nickel (Ni) and copper (Cu).

Another embodiment provides a method of manufacturing a multilayer ceramic capacitor which includes: applying and reducing a metal-organic decomposition (MOD) ink to a surface of a capacitor body including a plurality of dielectric layers and a plurality of internal electrode layers stacked with the dielectric layers interposed therebetween to form a metal particle film; applying a paste including a conductive metal and a glass composition to a surface of the capacitor body on which the metal particle film is formed; and firing the paste to form an external electrode including an inner layer formed from the metal particle film and an outer layer covering the inner layer and formed from the paste, wherein the inner layer includes a conductive metal and glass, and an area occupied by the glass is greater than about 0% and less than or equal to about 6% of a total area of the inner layer.

The metal-organic decomposition (MOD) ink may include a metal ligand material, an amine compound, a binder, an antioxidant, and a solvent.

The applying of the metal-organic decomposition (MOD) ink may be performed at a thickness of about 50 μm to about 400 μm.

The reducing may be performed at a temperature of about 170° C. to about 300° C. for about 30 minutes to about 3 hours.

The metal particle film may include metal nanoparticles having a size of about 10 nm to about 50 nm.

The glass composition may be included in an amount of about 10 wt % to about 30 wt % based on a total amount of the paste.

A multilayer ceramic capacitor according to some embodiments may have excellent capacitance characteristics, electrical characteristics, and moisture resistance reliability as the connectivity between the internal electrode layers and the external electrodes is improved.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure in the capacitor body of FIG. 1.

FIG. 5 is a schematic view showing an external electrode of a multilayer ceramic capacitor according to an embodiment.

FIGS. 6A and 6B are low-magnification SEM (scanning electron microscope) analysis images of the external electrodes of the multilayer ceramic capacitors according to Comparative Example 1 and Example 1, respectively.

FIGS. 7A and 7B are high-magnification SEM (scanning electron microscope) analysis images of the external electrodes of the multilayer ceramic capacitors according to Comparative Example 1 and Example 1, respectively.

FIG. 8 is a SEM (scanning electron microscope) analysis image of the external electrode of the multilayer ceramic capacitor according to Example 1.

FIGS. 9A and 9B are EPMA (electron probe microanalysis) images of the external electrodes of the multilayer ceramic capacitors according to Comparative Example 1 and Example 1, respectively, showing Cu diffusion.

FIGS. 10A and 10B are EPMA (electron probe microanalysis) images of the external electrodes of the multilayer ceramic capacitors according to Comparative Example 1 and Example 1, respectively, showing Ni diffusion.

FIGS. 11A and 11B are EPMA (electron probe microanalysis) images of the external electrodes of the multilayer ceramic capacitors according to Comparative Example 1 and Example 1, respectively, showing the distribution of glass.

FIG. 12 is EBSD (electron backscatter diffraction) images of the external electrodes of the multilayer ceramic capacitors according to Comparative Example 1 and Example 1.

FIG. 13 is a graph showing the capacitance characteristics of the multilayer ceramic capacitors according to Comparative Example 1 and Example 1.

FIG. 14 is a graph showing the equivalent series resistance (ESR) of the multilayer ceramic capacitors according to Comparative Example 1 and Example 1.

FIG. 15 is a graph showing the DC resistance (Rdc) of the multilayer ceramic capacitors according to Comparative Example 1 and Example 1.

FIG. 16A is a graph showing the moisture resistance reliability of the multilayer ceramic capacitor according to Comparative Example 1.

FIG. 16B is a graph showing the moisture resistance reliability of the multilayer ceramic capacitor according to Example 1.

FIG. 16C is a photograph showing the occurrence of defects in multilayer ceramic capacitors according to Comparative Example 1 and Example 1.

### DETAILED DESCRIPTION OF THE EMBODIMENTS

Hereinafter, the present disclosure will be described in detail with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be disposed above or below the reference element, and it is not necessarily referred to as being disposed “on”or “above”in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Additionally, throughout the specification, when it is said to “include as a main component,” it means that among at least one component present in an area, one component has the highest content based on a total amount of components.

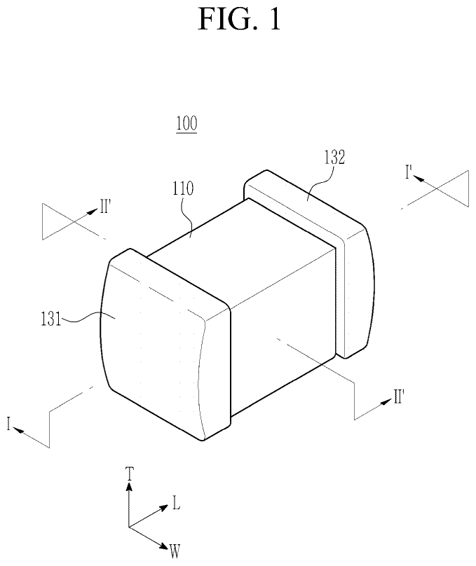

Hereinafter, a multilayer ceramic capacitor according to an embodiment will be described with reference to FIGS. 1 to 4.

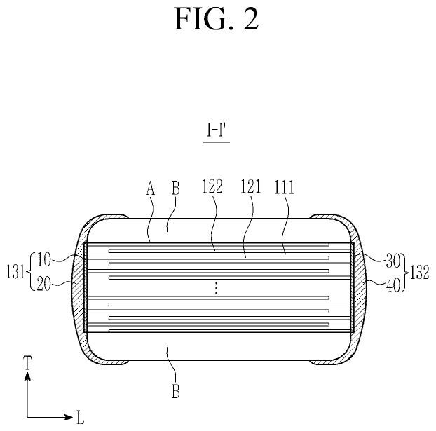

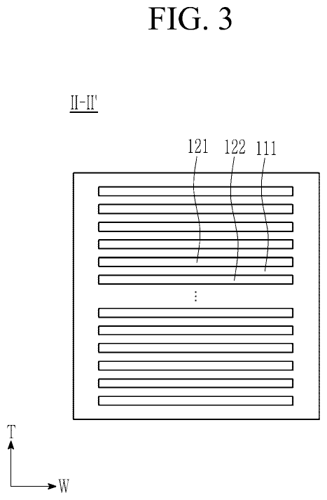

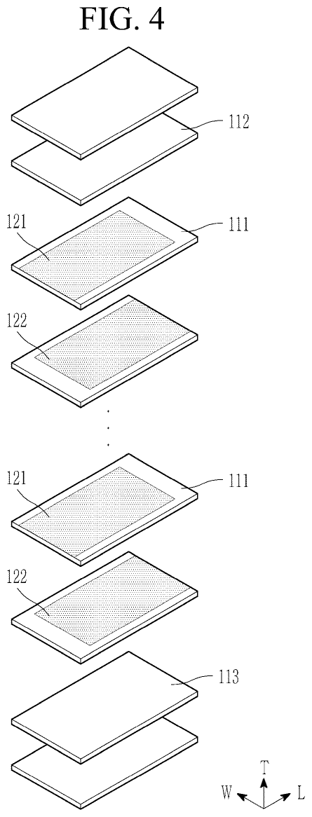

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be, for example, used as the same concept as a stacking direction in which a dielectric layer 111 are stacked. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111, and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which may contribute to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be disposed on opposite side ends of the active region in the width direction (W-axis direction), that is, on the fifth surface and the sixth surface, respectively. The side margin region may be formed by stacking the dielectric green sheet on which the conductive paste layer for the internal electrode is partially applied, and then fired. Thus, the side margin region may be side surfaces of the dielectric green sheet where the conductive paste layer are not applied. A method of forming the side margin portion may not be limited thereto.

The cover regions 112 and 113 and the side margin region may serve to prevent damage to the internal electrode layers 121 and 122 due to physical or chemical stress.

Detailed descriptions of the dielectric layer 111 and the internal electrode layers 121 and 122 will be provided later.

### External Electrode

According to some embodiments, the external electrodes 131 and 132 may be provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges may be accumulated between the first internal electrode layer 121 and the second internal electrode layer 122 facing each other. At this time, the capacitance of the multilayer ceramic capacitor 100 may be proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces of the capacitor body 110.

The first and second band portions may extend, respectively, from the first and second connection portions to portions of the first and second surfaces of the capacitor body 110 or the fifth and sixth surfaces of the capacitor body 110. The first and second band portions may serve to improve the adhesion strength of the first external electrode 131 and the second external electrode 132.

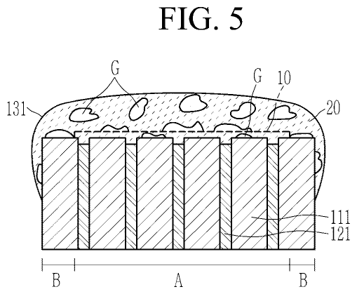

FIG. 5 is a schematic view showing an external electrode of a multilayer ceramic capacitor according to some embodiments of the present disclosure.

Referring to FIG. 2 and FIG. 5, the external electrodes 131 and 132 according to some embodiments respectively may include inner layers 10 and 30 that are disposed on a surface of the active region A of the capacitor body 110 and connected to internal electrode layers 121 and 122, and outer layers 20 and 40 that cover the inner layers 10 and 30, respectively. Specifically, the first external electrode 131 may include a first inner layer 10 connected to the first internal electrode layer 121, and a first outer layer 20 covering the first inner layer 10. Additionally, the second external electrode 132 may include a second inner layer 30 connected to the second internal electrode layer 122, and a second outer layer 40 covering the second inner layer 30.

The inner layers 10 and 30 may include a conductive metal and glass (G). The glass (G) may be included in an amount of greater than about 0 wt % and less than or equal to about 5 wt %, for example, about 0.01 wt % to about 5 wt %, about 0.1 wt% to about 4.5 wt %, or about 1 wt % to about 4 wt % based on a total amount of the inner layers 10 and 30. Additionally, the conductive metal may be included in an amount of greater than about 95 wt % and less than about 100 wt %, for example, about 95 wt % to about 99.99 wt %, about 95.5 wt % to about 99.9 wt %, or about 96 wt % to about 99 wt % based on a total amount of the inner layers 10 and 30. When the inner layers made of the conductive metal and glass have the above composition, the connectivity between the internal electrode layer and the external electrode can be improved as the contact between the internal electrode layer and the external electrode is strengthened. Accordingly, a multilayer ceramic capacitor having excellent capacitance characteristics, electrical characteristics, and moisture resistance reliability can be obtained. Additionally, the small amount of glass may partially supplement the interfacial bonding strength between the external electrode and the dielectric layer.

According to some embodiments, the area occupied by the glass in the inner layers 10 and 30 may be greater than about 0% and less than or equal to about 6%, for example, about 0.1% to about 5.5%, about 0.5% to about 5.0%, or about 1% to about 4.5%, based on a total area of the inner layers 10 and 30. When the area occupied by the glass in the inner layer is within the above range, the connectivity between the internal electrode layer and the external electrode may be improved, so that a multilayer ceramic capacitor having excellent capacitance characteristics, electrical characteristics, and moisture resistance reliability can be secured.

Specifically, the inner layers 10 and 30 may be defined as a region from an interface between the external electrodes 131 and 132 and the internal electrode layers 121 and 122 to a depth of about 1 μm to about 5 μm from the interface, for example, about 2 μm to about 4 μm from the interface, in the vertical direction of the stacking direction, i.e., in the length (L-axis) direction of the multilayer ceramic capacitor, toward the external electrodes 131 and 132.

The area of the glass within the inner layers 10 and 30 can be measured in the following manner. A multilayer ceramic capacitor 100 is loaded onto a tape with the L-axis and T-axis direction surfaces (LT surfaces) facing upward, placed in an epoxy mixing solution, and cured. Then, the LT surface of the capacitor body 110 is polished to ½ of the point in the W-axis direction, thereby obtaining a cross-sectional sample having an LT surface so that the external electrode can be observed. Next, one side of the obtained cross-sectional sample can be measured using a scanning electron microscope (SEM) to reveal the capacitor body and external electrodes. For example, SEM may be measured at an accelerating voltage of 20 kV and a magnification of 10 k. In the SEM image of the obtained cross-sectional sample, a region can be designated as an inner layer within the external electrode, specifically, a region from the interface between the external electrode and the internal electrode layer to a depth of about 1 μm to about 5 μm from the interface, for example, about 2 μm to about 4 μm from the interface, in the direction perpendicular to the stacking direction toward the external electrode. Next, an area occupied by the glass in the inner layer may be obtained. Glass does not exhibit conductivity, and thus it appears darker in SEM images compared to metals, allowing for the determination of the area ratio relative to the entire inner layer.

In general, the first method to secure connectivity between the internal electrode layer and the external electrode is to increase the degree of exposure of the internal electrode layer between the dielectric layers so that the external electrode can be connected to the exposed internal electrode layer. However, when applying an etching method to increase the exposure of the internal electrode layer, damage may be caused to the entire chip in addition to the electrode portion, which affects electrical characteristics such as reliability deterioration.

As a second method, a method of forming electrodes using direct plating, which is a method of directly connecting external electrodes to internal electrode layers, is being introduced. However, the direct plating method is not suitable for applying a large number of chips at once or for maintaining consistent quality. In addition, since the direct energy applied to the chip is small, no physical damage occurs, but as the formation of the plating electrode progresses, chemical reactions or damage caused by the plating solution may occur. Because of this, there is a disadvantage that it can only be applied selectively to some models.

In addition, conventionally, external electrodes may be formed by applying a paste including metal particles and then performing heat treatment, and due to a decrease in thickness caused by the thinning of the internal electrode layer, the metal particles may become larger than the thickness of the internal electrode layer. This may cause the connectivity between the internal electrode layer and the external electrode to deteriorate, resulting in side effects such as a decrease in capacitance and an increase in equivalent series resistance (ESR).

In addition, when forming an external electrode through direct plating, a metal layer such as Cu or Ni or a conductive polymer layer should be implemented on the internal electrode layer in order to proceed with plating. The plating may be performed on the implemented conductive polymer layer, or plating may be formed from a metal layer corresponding to a support layer formed on the band portion.

According to some embodiments, since the external electrode has an inner layer including a conductive metal as a main component and a small amount of glass, it may not only be distinguished from a layer formed by a conventional plating method, but also the connectivity between the internal electrode layer and the external electrode can be improved due to, for example, an increase in the Ni—Cu alloy.

Specifically, the inner layers 10 and 30 according to some embodiments can be formed by applying a metal organic decomposition (MOD) ink including a metal ligand material to a surface of the capacitor body 110. This may be a method in which a metal ligand material generates fine metal particles at the end of the internal electrode layer through a reduction process. Since it does not include a dispersant for dispersing the metal particles, a physical distance from the internal electrode layer and a gap between the metal particles can be significantly reduced. This is because, in addition to the effect of reducing the distance between the metal particles, the metal particles are formed at the end of the internal electrode layer having a sunken structure, which can improve the contact between the internal electrode layer and the external electrode during the sintering process of the final electrode, for example, with an increase in the Ni—Cu alloy.

In addition, according to some embodiments, the inner layers 10 and 30 can be formed without a support layer, as compared to a conventional plating layer, and the inner layers 10 and 30 can be formed only on the active region A of the capacitor body 110 in the final product. Additionally, in the case of the conventional plating layer, no other material such as glass is found other than the metal particles, but according to some embodiments of the present disclosure, the inner layer disposed between the external electrode and the capacitor body may include a small amount of glass.

According to some embodiments, the external electrodes 131 and 132 can be formed by applying and reducing a metal-organic decomposition (MOD) ink including a metal ligand material to a surface of a capacitor body 110 to form a metal particle film, then applying a paste including a conductive metal and a glass composition thereon, and then firing. The external electrodes 131 and 132 formed thereby include inner layers 10 and 30 formed from the metal particle film and outer layers 20 and 40 formed from the paste. The conductive metal included in the inner layers 10 and 30 may be derived from the metal ligand material of the MOD ink, and the glass included in the inner layers 10 and 30 may be derived from the glass composition of the paste. That is, since the process of forming the inner layers 10 and 30 is not a method of growth like a plating method, the glass composition included in the secondarily applied paste can move and become the glass included in the inner layers 10 and 30.

The conductive metal included in the inner layers 10 and 30 may include one or more selected from the group consisting of copper (Cu), nickel (Ni), silver (Ag), palladium (Pd), gold (Au), platinum (Pt), tin (Sn), tungsten (W), titanium (Ti), lead (Pb), and an alloy thereof, and may include, for example, copper (Cu).

For example, the inner layers 10 and 30 may include copper (Cu) and nickel (Ni). At this time, nickel (Ni) may have diffused from nickel (Ni) of the internal electrode layers 121 and 122 as the contact between the external electrode and the internal electrode layer is strengthened.

The glass of the inner layers 10 and 30 may include at least one selected from the group consisting of aluminum oxide (Al₂O₃), silicon dioxide (SiO₂), lithium oxide (Li₂O), sodium oxide (Na₂O), iron (III) oxide (Fe₂O₃), zinc oxide (ZnO), barium oxide (BaO), calcium oxide (CaO), boron trioxide (B₂O₃), and tin (IV) oxide (SnO₂), but is not limited thereto.

The inner layers 10 and 30 may have a structure that extends into the interior of the capacitor body 110 and is connected to the internal electrode layers 121 and 122. In other words, at least some of the internal electrode layers 121 and 122 may have a sunken structure based on a surface of the capacitor body 110. When having the above structure, the Cu-Ni alloy can increase at the interface between the inner layer of the external electrode and the internal electrode layer, and accordingly, the contact between the internal electrode layer and the external electrode can be strengthened.

The interface between the inner layers 10 and 30 of the external electrodes 131 and 132 and the internal electrode layers 121 and 122 may include a Cu—Ni alloy. When an amount of the Cu—Ni alloy increases at the interface between the inner layer of the external electrode and the internal electrode layer, the connectivity between the internal electrode layer and the external electrode can be increased.

The glass of the inner layers 10 and 30 may be present on a surface of the dielectric layer 111 within the active region A of the capacitor body 110, and may, for example, be present only on a surface of the dielectric layer 111. In other words, the glass of the inner layers 10 and 30 may exist at the interface between the dielectric layer 111 and the external electrodes 131 and 132. In addition, the glass can be thinly spread on a surface of the dielectric layer 111 without clumping. By thinly spreading the glass only on a surface of the dielectric layer 111, the contact between the internal electrode layer and the external electrode can be strengthened.

The structure, components and content of the external electrodes 131 and 132 according to some embodiments can be confirmed by SEM (scanning electron microscope) analysis and EPMA (electron probe microanalysis).

Specifically, a multilayer ceramic capacitor 100 is loaded onto a tape with the L-axis and T-axis direction surfaces (LT surfaces) facing upward, placed in an epoxy mixing solution, and cured. Then, the LT surface of the capacitor body 110 is polished to ½ of the point in the W-axis direction, thereby obtaining a cross-sectional sample having an LT surface so that the external electrode can be observed. Next, one side of the obtained cross-sectional sample can be measured using a scanning electron microscope (SEM) to reveal the capacitor body and external electrodes. For example, SEM may be measured at an accelerating voltage of 20 kV and a magnification of 10k.

Additionally, electron probe micro-analyzer (EPMA) can be performed on the cross-sectional sample obtained by the above-described method. For example, EPMA can identify the components and contents of an external electrode by measuring at an accelerating voltage of 20 kV and a magnification of 3 k.

According to some embodiments, since the external electrodes 131 and 132 have the inner layers 10 and 30 at the interface with the active region A of the capacitor body 110, the connectivity between the external electrodes and the internal electrode layers can be about 90% to about 100%, for example, about 91% to about 100%, or about 92% to about 100%. As the connectivity between the external electrode and the internal electrode layer is within the above range, a multilayer ceramic capacitor having excellent capacitance characteristics, electrical characteristics, and moisture resistance reliability can be obtained.

The connectivity between the external electrode and the internal electrode layer can be obtained by SEM analysis. Specifically, in the SEM image of the cross-sectional sample obtained by the above-described method, when the junction surface of the external electrodes 131 and 132 and the capacitor body 110 is divided into three portions in the stacking direction, i.e., the thickness direction (T-axis direction) of the multilayer ceramic capacitor, and divided into the upper portion, the center portion, and the lower portion, the connectivity is measured for each area and the average value thereof was calculated. Here, the connectivity can be obtained for each region by Equation 1.

### Equation 1

Connectivity of external electrodes and internal electrode layers (%)=(Number of internal electrode layers connected to external electrodes/Total number of internal electrode layers)×100

Each thickness of the inner layers 10 and 30 may be about 1 μm to about 5 μm, for example about 1 μm to about 4 μm, about 1.1 μm to about 3μm, about 1.2 μm to about 2.9 μm, or about 1.3 μm to about 2.8 μm. When the thickness of the inner layer is within the above range, the connectivity between the internal electrode layer and the external electrode can be improved.

Each thickness of the inner layers 10 and 30 may be obtained by SEM analysis. Specifically, in the SEM image of the cross-sectional sample obtained by the above-described method, the thickness of the inner layers 10 and 30 disposed between the active region A of the capacitor body 110 and the external electrodes 131 and 132 can be measured. The central point in the thickness direction (T-axis direction) of the multilayer ceramic capacitor 100 in the inner layers 10 and 30 is used as a reference point, and the arithmetic mean value of the thickness of the inner layers 10 and 30 at 10 points spaced apart from the reference point by a predetermined interval can be obtained. The intervals between the 10 points may be adjusted according to the scale of the SEM image, and may be, for example, about 1 μm to about 100 μm, about 1 μm to about 50 μm, or about 1 μm to about 10 μm. At this time, all 10 points should be disposed within the inner layers 10 and 30, and if all 10 points are not disposed within the inner layers 10 and 30, the position of the reference point may be changed or the interval between the 10 points may be adjusted.

The inner layers 10 and 30 may include grains. That is, the conductive metal included in the inner layers 10 and 30 may have a form of grains. The grain size of the conductive metal may be about 0.5 μm to about 1 μm, for example about 0.55 μm to about 0.95 μm, or about 0.6 μm to about 0.9 μm.

The grain size of the conductive metal can be obtained by EBSD (electron backscatter diffraction) analysis. Specifically, the inner layers 10 and 30 of the external electrodes 131 and 132 can be seen in the cross-sectional sample obtained by the above-described method by measuring the electron backscatter diffraction (EBSD). For example, EBSD may be measured at an acceleration voltage of 15 kV, a step size of 0.025 μm, a scan area of 16 μm×4 μm, a grain boundary disorientation of 10°, and a magnification of 3 k.

When straight lines of the same length are drawn from the obtained EBSD image, the grain size of the conductive metal can be calculated by Equation 2.

### Equation 2

Grain size (μm)=(total length of all straight lines)/(total number of intersections between straight lines and grains)

The outer layers 20 and 40 may include a conductive metal and glass. Here, the conductive metal of the outer layers 20 and 40 may be the same as or different from the conductive metal of the inner layers 10 and 30 described above, and the glass of the outer layers 20 and 40 may be the same as or different from the glass of the inner layers 10 and 30 described above.

The outer layers 20 and 40 may include about 70 wt % to about 90 wt % of the conductive metal and about 10 wt % to about 30 wt % of the glass, for example about 75 wt % to about 85 wt % of the conductive metal and about 15 wt % to about 25 wt % of the glass. When the outer layer has the above composition, a multilayer ceramic capacitor having excellent capacitance characteristics, electrical characteristics, and moisture resistance reliability can be obtained.

The external electrodes 131 and 132 may further include a conductive resin layer disposed on the outer layers 20 and 40 to cover the aforementioned outer layers 20 and 40, and a plating layer disposed to cover the conductive resin layer.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the outer layers 20 and 40 are extended and disposed to the first and second surfaces or the fifth and sixth surfaces of the capacitor body 110. That is, the conductive resin layer may be formed on the outer layers 20 and 40, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the inner layers 10 and 30 and outer layers 20 and 40.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outer surface the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), lead (Pb), and alloys thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers. In some embodiments, the plating layer does not include copper (Cu).

The plating layer may improve mountability to the substrate, structural reliability, durability to the outer surface, heat resistance, and equivalent series resistance (ESR) of the multilayer capacitor 100.

### Dielectric Layer and Internal Electrode Layer

According to some embodiments, the dielectric layer 111 may include a barium titanate-based compound including barium (Ba) and titanium (Ti) as a main component. The barium titanate-based compound is a dielectric base material, has a high dielectric constant, and contributes to forming the dielectric constant of a multilayer ceramic capacitor 100. For example, the barium titanate-based compound may include at least one selected from the group consisting of BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

The dielectric layer 111 may further include subcomponent. The subcomponent may include one or more selected from the group consisting of, for example, manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.1 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 can be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers. In a scanning electron microscope (SEM) image of a measured cross-sectional sample, a central point in the length direction (L-axis direction) or width direction (W-axis direction) of the dielectric layer 111 is used as a reference point, and an arithmetic mean value of the thickness of the dielectric layer 111 at 10 points spaced at a predetermined interval from the reference point can be obtained. The intervals of the 10 points may be adjusted depending on the scale of the SEM image, and may be, for example, about 1 μm to about 100 μm, about 1 μm to about 50 μm, or about 1 μm to about 10 μm. At this time, all 10 points should be disposed within the dielectric layer 111, and if all 10 points are not disposed within the dielectric layer 111, the position of the reference point may be changed, or the interval between the 10 points may be adjusted.

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 may include a conductive metal, and may include, for example, a metal such as Ni, Cu, Ag, Pd, Au, or an alloy thereof, for example, an Ag—Pd alloy.

For example, the internal electrode layers 121 and 122 may include nickel (Ni) and copper (Cu). At this time, copper (Cu) may have diffused from the copper (Cu) forming the inner layers 10 and 30 of the external electrodes 131 and 132 as the contact between the external electrode and the internal electrode layer is strengthened.

Additionally, the internal electrode layers 121 and 122 may include dielectric particles having the same composition as the ceramic material included in the dielectric layer 111.

The internal electrode layers 121 and 122 may be formed using a conductive paste including a conductive metal. The printing method for the conductive paste may be either screen printing or gravure printing.

An average thickness of the internal electrode layers 121 and 122 may be about 0.1 μm to about 2 μm. When the average thickness of the internal electrode layers 121 and 122 is within the above range, the reliability of the multilayer ceramic capacitor is improved.

The average thickness of the internal electrode layers 121 and 122 can be measured by scanning electron microscope (SEM) analysis. Specifically, in a scanning electron microscope (SEM) image of a cross-sectional sample measured as described above, a central point in the length direction (L-axis direction) or width direction (W-axis direction) of the internal electrode layers 121 and 122 is used as a reference point, and an arithmetic mean value of the thickness of the internal electrode layers 121 and 122 at 10 points spaced at a predetermined interval from the reference point can be obtained. The intervals between the 10 points may be adjusted according to the scale of the scanning electron microscope (SEM) image, and may be, for example, about 1 μm to about 100 μm, about 1 μm to about 50 μm, or about 1 μm to about 10 μm. At this time, all 10 points should be disposed within the internal electrode layers 121 and 122, and if all 10 points are not disposed within the internal electrode layers 121 and 122, the position of the reference point may be changed or the interval between the 10 points may be adjusted.

The capacitor body 110 may be formed by firing a stacking structure in which the plurality of dielectric layers 111 and internal electrode layers 121 and 122 are stacked.

Hereinafter, a method of manufacturing the multilayer ceramic capacitor 100 according to an embodiment will be described.

### Method of Manufacturing Multilayer Ceramic Capacitor

The multilayer ceramic capacitor 100 according to some embodiments may be manufactured by applying and reducing a metal-organic decomposition (MOD) ink to a surface of a capacitor body 110 to form a metal particle film; applying a paste including a conductive metal and a glass composition to a surface of the capacitor body on which the metal particle film is formed; and firing the paste to form an external electrodes 131 and 132 including inner layers 10 and 30 formed from the metal particle film and outer layers 20 and 40 formed from the paste and covering the inner layers.

Hereinafter, a method of manufacturing the capacitor body 110 will be described.

The capacitor body 110 may be manufactured by manufacturing a dielectric green sheet using the dielectric slurry and forming a conductive paste layer on the surface of the dielectric green sheet; manufacturing a dielectric green sheet stack by stacking the dielectric green sheet on which the conductive paste layer is formed; and firing the dielectric green sheet stack.

The dielectric slurry may be prepared by mixing a barium titanate-based main component powder and, optionally, a subcomponent powder.

Since the barium titanate-based main component powder is the same as the barium titanate-based main component included in the dielectric layer, its description is omitted here.

The subcomponent powder may include at least one selected from the group consisting of manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), and a combination thereof, but is not limited thereto. Each of the subcomponent powder may be included in an amount of about 0.01 parts by mole to about 5 parts by mole based on 100 parts by mole of the barium titanate-based main component powder.

The subcomponent powder may be used in a form of an oxide or salt compound including each metal, or may be used in a form of a sol dispersed in an organic solvent.

In addition, the dielectric slurry may be prepared by additionally mixing additives such as a dispersant, a binder, a plasticizer, a lubricant, an antistatic agent, and a solvent.

The barium titanate-based main component powder and optionally the subcomponent powder may be mixed using a wet ball mill or a stirring mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste may be prepared by mixing a conductive powder made of a conductive metal or an alloy thereof, a binder, and a solvent. Additionally, a barium titanate powder may be mixed in as a co-material if necessary. The co-material may act to suppress sintering of the conductive powder during the firing process. In the step of manufacturing the dielectric green sheet, a dielectric slurry may be prepared by mixing a barium titanate-based compound as a main component powder and optionally a subcomponent powder.

The conductive powder may include nickel (Ni) or a nickel (Ni) alloy.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body is manufactured after binder removal treatment and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen. When the internal electrode includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500 ° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode and the second internal electrode may be exposed to the outermost surfaces of the third and fourth surfaces, and thus the electrical connection between the first external electrode and the second external electrode, and the first internal electrode and the second internal electrode may be improved, alloy portions may be easily formed.

Next, a method for manufacturing external electrodes 131 and 132 is described.

A metal-organic decomposition (MOD) ink is applied and reduced on a surface of the above-mentioned manufactured capacitor body 110 to form a metal particle film.

The metal-organic decomposition (MOD) ink is applied to at least the third surface and the fourth surface of the capacitor body 110, and optionally also to a portion of the first surface, the second surface, the fifth surface, or the sixth surface on which the band portions of the first external electrode and the second external electrode are formed.

The metal-organic decomposition (MOD) inks may include a metal ligand material, an amine compound, a binder, an antioxidant, and a solvent.

The metal ligand material may include a conductive metal formate formed by reacting a conductive metal precursor with formic acid.

The conductive metal precursor may be a precursor including a conductive metal including at least one selected from the group consisting of copper (Cu), nickel (Ni), silver (Ag), palladium (Pd), gold (Au), platinum (Pt), tin (Sn), tungsten (W), titanium (Ti), lead (Pb), alloys thereof, and a combination thereof. Examples of such a conductive metal precursor may include metal oxide, metal hydroxide, metal nitrate, metal carbonate, metal sulfate, metal chloride, metal acetate, or a combination thereof.

The metal ligand material may be included in an amount of about 20 wt % to about 40 wt % based on a total amount of the metal-organic decomposition (MOD) ink.

Examples of the amine compound may include butylamine, hexylamine, octylamine, dibutylamine, triethylamine, diethylenetriamine, ethylenediamine, cyclohexylamine, aminomethylpropanol, 2-amino-2-methyl-1-propanol (AMP), or a combination thereof.

The amine compound may be included in an amount of about 20 wt % to about 60 wt % based on a total amount of the metal-organic decomposition (MOD) ink.

The binder may include at least one selected from the group consisting of a thermoplastic resin, a thermosetting resin, a natural polymer, and a combination thereof. Examples of the thermoplastic resin may include at least one selected from the group consisting of an acrylic resin, a cellulose resin, an aliphatic or copolymerized polyester resin, a vinyl resin, a polyamide resin, a polyurethane resin, a polyether resin, a urea resin, an alkyd resin, a silicone resin, a fluorine resin, and an olefin resin, etc. The acrylic resin may be, for example, polyacrylic acid, polyacrylic acid ester, etc. Examples of the thermosetting resin may include at least one selected from the group consisting of an epoxy resin, an unsaturated or vinyl polyester resin, a diallyl phthalate resin, a phenol resin, an oxetane resin, an oxazine resin, a bismaleimide resin, a modified silicone resin, and a melamine resin, etc. Examples of the natural polymer may include at least one selected from the group consisting of an ethylene-propylene rubber (EPR), a styrene-butadiene rubber (SBR), and starch, gelatin, etc.

The binder may be included in an amount of about 0.1 wt % to about 5 wt % based on a total weight of the metal-organic decomposition (MOD) ink.

The antioxidant may include organic acid such as oleic acid.

The antioxidant may be included in an amount of about 0.1 wt % to about 5 wt % based on a total weight of the metal-organic decomposition (MOD) ink.

The solvent may include at least one selected from the group consisting of water; an alcohol solvent such as methanol, ethanol, isopropanol, 1-methoxypropanol, butanol, ethylhexyl alcohol, and terpineol; glycol solvents such as ethylene glycol and glycerin; acetate solvents such as ethyl acetate, butyl acetate, methoxypropyl acetate, carbitol acetate, and ethyl carbitol acetate; ether solvents such as methyl cellosolve, butyl cellosolve, diethyl ether, tetrahydrofuran, and dioxane; a ketone solvent such as methyl ethyl ketone, acetone, dimethylformamide, and 1-methyl-2-pyrrolidone; a hydrocarbon solvent such as hexane, heptane, dodecane, paraffin oil, and mineral spirit; an aromatic solvent such as benzene, toluene, and xylene; a halogen-substituted solvent such as chloroform, methylene chloride, and carbon tetrachloride. or a combination thereof.

The solvent may be included as a balance amount based on a total amount of the metal-organic decomposition (MOD) ink.

The metal-organic decomposition (MOD) ink may be applied with a thickness of about 50 μm to about 400 μm, for example, with a thickness of about 80 μm to about 350 μm. When the metal-organic decomposition (MOD) ink is applied within the above thickness range, an inner layer formed after firing can be formed with an appropriate thickness, thereby enhancing the contact between the internal electrode layer and the external electrode.

The reducing may be carried out in a nitrogen atmosphere, at a temperature of about 170° C. to about 300° C., for example, at a temperature of about 180° C. to about 250° C., for about 30 minutes to about 3 hours, for example, for about 40 minutes to about 2 hours. When reduced under conditions within the above range, the contact between the internal electrode layer and the external electrode can be strengthened due to the formation of the inner layer.

When the metal-organic decomposition (MOD) ink is applied to a surface of a capacitor body 110 and reduced, a metal particle film including very small and uniform metal nanoparticles can be formed. For example, the metal particle film may include metal nanoparticles having a size of about 10 nm to about 50 nm, for example, metal nanoparticles having a size of about 15 nm to about 45 nm.

Subsequently, the paste is applied to a surface of the capacitor body 110 on which a metal particle film is formed, and then fired.

The paste includes a conductive metal and a glass composition.

The glass composition may be included in an amount of about 10 wt % to about 30 wt %, for example about 12 wt % to about 28 wt %, or about 14 wt % to about 26 wt % based on a total amount of the paste.

Since the descriptions of the conductive metal and glass composition are the same as that of the conductive metal and glass described above, the descriptions thereof are omitted here.

The paste may further include a binder, a solvent, a dispersant, a plasticizer, an oxide powder, etc.

The binder may include, for example, ethyl cellulose or acrylic, butyral, etc., and the solvent may include, for example, an organic solvent or aqueous solvent such as terpineol, butyl carbitol, alcohol, methyl ethyl ketone, acetone, toluene, and the like.

Methods for applying the paste on a surface of the capacitor body 110 may include various printing methods such as dip method and screen printing, application method using a dispenser, etc., and spraying method using spray. The paste may be applied to at least the third and fourth surfaces of the capacitor body 110, and optionally applied to a portion of the first, second, fifth, or the sixth surfaces on which the band portions of the first and second external electrodes are formed.

The firing may be performed at a temperature of about 700° C. to about 800° C., for example, about 720° C. to about 740° C., for about 0.5 hour to about 3 hours, for example, about 1 hour to about 2 hours.

Optionally, a paste for forming the conductive resin layer is applied on an outer surface of the capacitor body 110 in which the outer layers 20 and 40 are formed on the inner layers 10 and 30 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethyl cellulose, acrylic, butyral, etc., and the solvent may be an organic solvent or aqueous solvent such as terpineol, butyl carbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer may be formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### Manufacturing of Multilayer Ceramic Capacitors

### Example 1

A dielectric green sheet was manufactured using BaTiO₃ powders, a conductive paste layer including Ni was printed on the surface of the dielectric green sheet, and the dielectric green sheets on which the conductive paste layers were formed were stacked and pressed to manufacture a dielectric green sheet stack. A capacitor body was manufactured by calcinating the dielectric green sheet stack at a temperature of 400° C. or less in a nitrogen atmosphere, and then firing under the conditions of a firing temperature of less than or equal to 1300° C. and a hydrogen concentration of less than or equal to 1.0% H₂.

A metal-organic decomposition (MOD) ink including 30 wt % of copper formate (Cu formate), 25 wt % of octylamine, 25 wt % of 2-amino-2-methyl-1-propanol (AMP), 0.5 wt % of oleic acid, 0.5 wt % of acrylic resin (SPB 80), and a balance amount of dihydroterpineol (DHT) was applied to a surface of a capacitor body to a thickness of 100 μm, and reduced at 200 ° C. for 1 hour under a nitrogen atmosphere to form a Cu particle film composed of Cu nanoparticles with an average size of less than or equal to 50 nm.

On a surface of the capacitor body on which the Cu particle film was formed, a paste including 70 wt % of Cu, 20 wt % of a glass composition, 5 wt % of an acryl-based resin (SPB 80), and a balance amount of dihydroterpineol (DHT) was applied and then, fired at 730° C. for 70 minutes to form an external electrode. Herein, the glass composition included 9.1 mol % of lithium oxide (Li₂O), 10 mol % of sodium oxide (Na₂O), 1.5 mol % of iron oxide (III) (Fe₂O₃), 6.3 mol % of zinc oxide (ZnO), 21 mol % of barium oxide (BaO), 11 mol % of silicon dioxide (SiO₂), 8 mol % of calcium oxide (CaO), 12 mol % of aluminum oxide (Al₂O₃), 20.2 mol % of boron trioxide (B₂O₃), and 1 mol % of tin oxide (IV) (SnO ₂).

Next, a multilayer ceramic capacitor was manufactured through processes such as plating and the like.

### Comparative Example 1

On a surface of the capacitor body on which the Cu particle film was formed, a paste including 70 wt % of Cu, 20 wt % of a glass composition, 5 wt % of an acryl-based resin (SPB 80), and a balance amount of dihydroterpineol (DHT) was applied and then, fired at 730° C. for 70 minutes to form an external electrode.

Next, a multilayer ceramic capacitor was manufactured through processes such as plating and the like.

### Evaluation 1: Sem Analysis

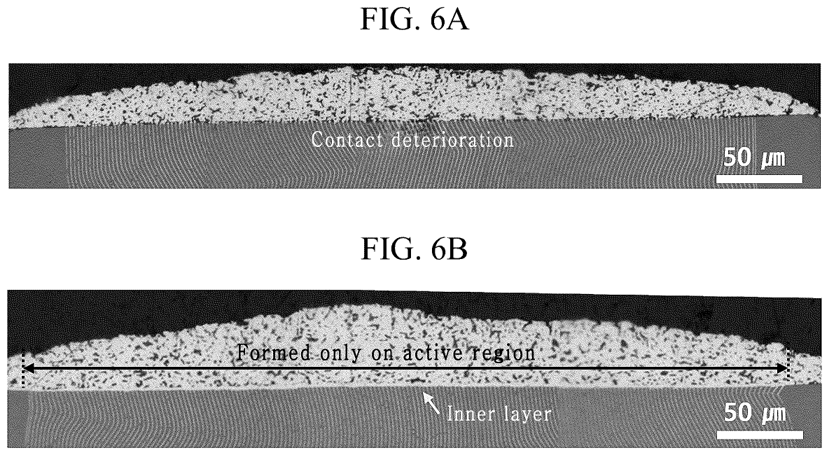

SEM (scanning electron microscope) analysis was performed on the multilayer ceramic capacitors manufactured in Example 1 and Comparative Example 1 by the following method, and the results are shown in FIGS. 6 to 8.

Each multilayer ceramic capacitor was loaded onto a tape with the L-axis and T-axis direction surfaces (LT surfaces) facing upward, placed in an epoxy mixing solution, and cured. Then, the LT surface of the capacitor body is polished to ½ of the point in the W-axis direction, thereby obtaining a cross-sectional sample having an LT surface so that the external electrode can be observed. Subsequently, one side of the obtained cross-sectional sample was measured by SEM to observe the capacitor body and external electrode. SEM was measured at an accelerating voltage of 20 kV and a magnification of 10 k.

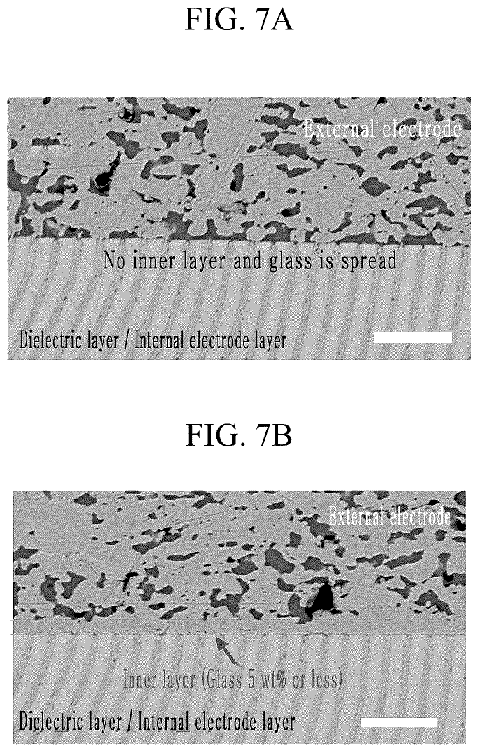

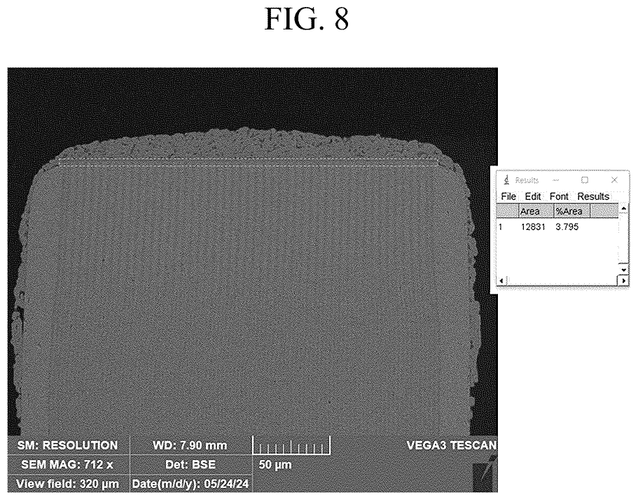

FIGS. 6A and 6B are low-magnification SEM (scanning electron microscope) analysis images of the external electrodes of the multilayer ceramic capacitors according to Comparative Example 1 and Example 1, respectively, FIGS. 7A and 7B are high-magnification SEM (scanning electron microscope) analysis images of the external electrodes of the multilayer ceramic capacitors according to Comparative Example 1 and Example 1, respectively, and FIG. 8 is a SEM (scanning electron microscope) analysis image of the multilayer ceramic capacitor according to Example 1.

Referring to FIGS. 6A to 7B, the external electrode of Comparative Example 1 had a structure that an inner layer was not formed on the interface with the capacitor body, but a large amount of glass was spread the interface with an internal electrode layer (refer to FIG. 6A and FIG. 7A). In addition, in the external electrode of Comparative Example 1, because glass with a size of 1 μm to 3 μm and a Cu flake with a size of 3 μm or more in addition to the Cu particles were mixed together, as the thickness of the internal electrode layer decreased, connectivity between the external electrode and the internal electrode layer was more deteriorated.

On the other hand, the external electrode manufactured in the MOD method according to Example 1 included an inner layer connected to the internal electrode layer on one side of an active region of the capacitor body and formed from the Cu particle film and an outer layer covering the inner layer and had a structure that the inner layer was mostly made of Cu but a small amount of glass was present only on the interface with the dielectric layer, that is, on the dielectric layer (refer to FIG. 6B and FIG. 7B). In other words, in Example 1, as the inner layer with the structure was formed on one side of the active region, the glass was prevented from being laid on the internal electrode layer, securing excellent connectivity between external electrode and internal electrode layer, compared with Comparative Example 1.

Specifically, referring to FIG. 8, in Example 1, an area occupied by the glass in the inner layer was measured to be 3.795% of a total area of the inner layer. Herein, the inner layer was designated as a region from the interface between the internal electrode layer and the external electrode on a surface of the active region of the capacitor body to a depth of 3 μm from the interface toward external electrode in a perpendicular direction to the stacking direction. The designated region of the inner layer was marked as a dotted line in FIG. 8.

In addition, in the SEM image obtained above, the joint surface between the external electrode and the capacitor body was divided into three portions such as upper, central, and lower portions in the stacking direction, that is, in a thickness (T-axis) direction of the multilayer ceramic capacitor to measure connectivity in each portion and then, calculate an average thereof. The connectivity in each portion was obtained according to Equation 1.

### Equation 1

Connectivity of external electrodes and internal electrode layers (%)=(Number of internal electrode layers connected to external electrodes/Total number of internal electrode layers)×100

As a result of the measurement, the connectivity between the external electrode and the internal electrode layer was 40% or less in Comparative Example 1 but 90% or more in Example 1.

Accordingly, the external electrode according to an embodiment had an inner layer, in which Cu was included as a main component, but a small amount of glass was thinly spread only on the dielectric layer on a surface of the active region, and thus exhibited excellent connectivity between external electrode and internal electrode layer.

### Evaluation 2: Epma Measurement

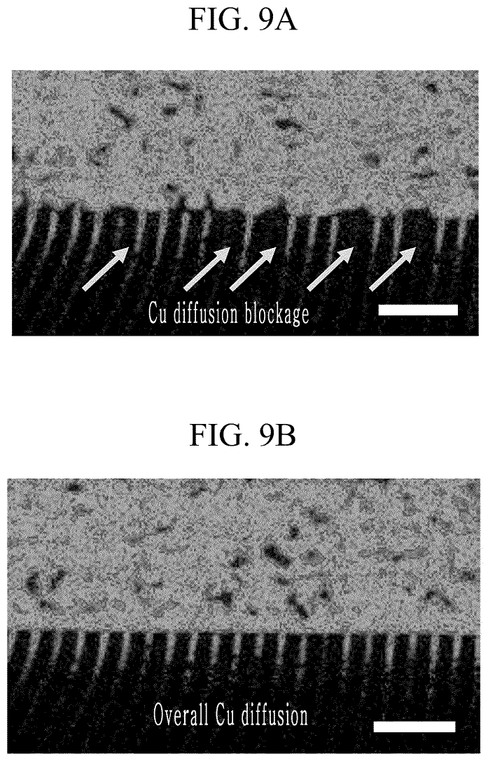

The multilayer ceramic capacitors according to Example 1 and Comparative Example 1 were subjected to EPMA (electron probe microanalysis) in the following method, and the results are shown in FIGS. 9A to 11B.

The cross-sectional samples of Evaluation 1 were used for EPMA at an accelerating voltage of 20 kV and a magnification of 2 k to check diffusion of Cu and Ni elements by analyzing peaks of Cu and Ni elements and to check glass distribution by analyzing a peak of O element.

FIGS. 9A and 9B, FIGS. 10A and 10B, and FIGS. 11A and 11B are EPMA (electron probe microanalysis) images of the external electrodes of the multilayer ceramic capacitors of Comparative Example 1 and Example 1, which respectively show Cu diffusions, Ni diffusions, and glass distributions.

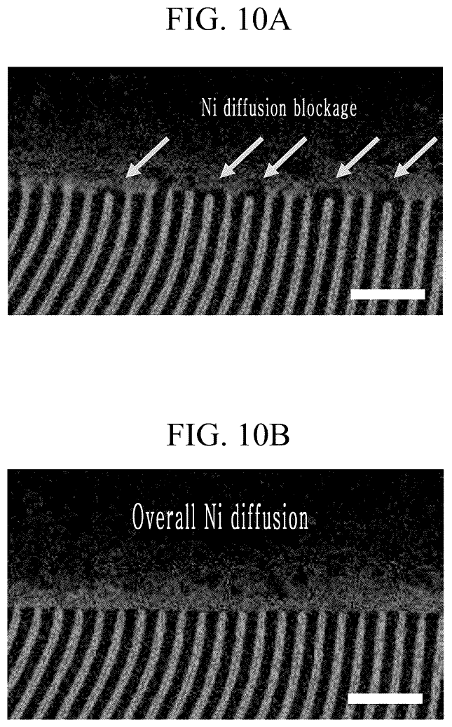

Referring to FIGS. 9A and 9B, because a portion where the external electrode of Comparative Example 1 was connected to the internal electrode layer was blocked, Cu was not diffused into the internal electrode layer (refer to FIG. 9A), but in Example 1, because the external electrode and the internal electrode layer were overall connected, Cu was uniformly diffused to the internal electrode layer (refer to FIG. 9B). Referring to FIGS. 10A and 10B, in Comparative Example 1, Ni was not diffused into the external electrode, where the connectivity of the internal electrode layer with the external electrode was deteriorated (refer to FIG. 10A), but in Example 1, Ni was diffused throughout the external electrode (refer to FIG. 10B). Accordingly, as the external electrode including the inner layer according to an embodiment had excellent connectivity with the internal electrode layer, Cu was not only diffused into the internal electrode layer, but also Ni was uniformly diffused into the external electrode.

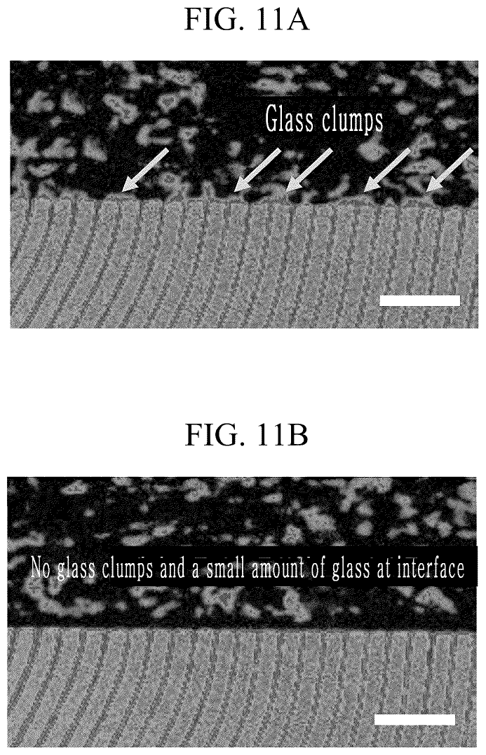

In addition, referring to FIGS. 11A and 11B, Comparative Example 1 exhibited glass clumps on the interface between the external electrode and the internal electrode layer. These deteriorated the connectivity between the external electrode and the internal electrode layer, thereby, deteriorating electrical characteristics of the multilayer ceramic capacitor. On the other hand, in Example 1, the glass clumps were not found on the interface between the external electrode and the internal electrode layer, but a small amount of glass was present only on the dielectric layer. The external electrode including the inner layer according to an embodiment exhibited excellent connectivity with the internal electrode layer.

### Evaluation 3: Ebsd Analysis

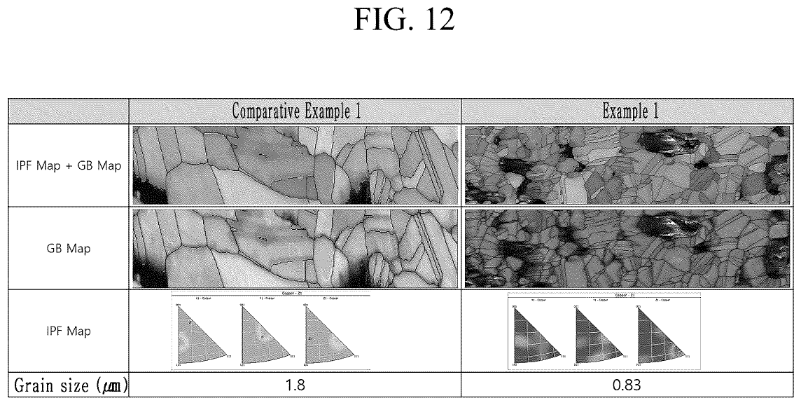

The multilayer ceramic capacitors according to Example 1 and Comparative Example 1 were subjected to EBSD (electron backscatter diffraction) analysis, and the results are shown in FIG. 12.

The cross-sectional samples of Evaluation 1 were used for EBSD analysis at an acceleration voltage of 15 kV, a step size of 0.025 μm, a scan area of 16 μm ×4 μm, a grain boundary disorientation of 10 °, and a magnification of 3 k. In the obtained EBSD images, when straight lines with the same length were drawn, a grain size of Cu was calculated according to Equation 2.

### Equation 2

Grain size (μm)=(total length of all straight lines)/(total number of intersections between straight lines and grains)

FIG. 12 is EBSD (electron backscatter diffraction) images of the external electrodes of the multilayer ceramic capacitors according to Comparative Example 1 and Example 1.

Cu used in forming the external electrode of Comparative Example 1 was present as a mixture of spherical particles of 500 nm and flake particles of 7 μm or larger. On the other hand, Cu nanoparticles included in the Cu particle film formed in Example 1 were fine spherical shape particles having an average size of 50 nm or less. Such a size difference of the Cu particles implemented a different grain size of Cu after the firing.

In other words, referring to FIG. 12, Cu included in the external electrode of Comparative Example 1 had a grain size of about 1.8 μm, but Cu included in the inner layer of the external electrode of Example 1 manufactured in the MOD method had a grain size of about 0.83 μm, which was reduced by about 50%.

### Evaluation 4: Capacitance Characteristics

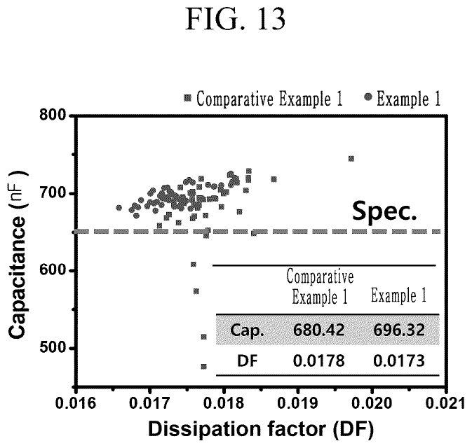

The multilayer ceramic capacitors according to Example 1 and Comparative Example 1 were measured with respect to capacitance and dielectric loss (DF) under condition of 120 Hz and 0.5 V, and the results are shown in FIG. 13.

FIG. 13 is a graph showing the capacitance characteristics of the multilayer ceramic capacitors according to Comparative Example 1 and Example 1.

Referring to FIG. 13, in the multilayer ceramic capacitor of Example 1 in which the inner layer of the external electrode was formed in the MOD method, compared with that of Comparative Example 1, capacitance distribution was reduced due to contact deterioration between the external electrode and the internal electrode layer, capacitance defects out of the specification were significantly improved, and a distribution of dielectric loss DF also was reduced.

### Evaluation 5: Electrical Characteristics

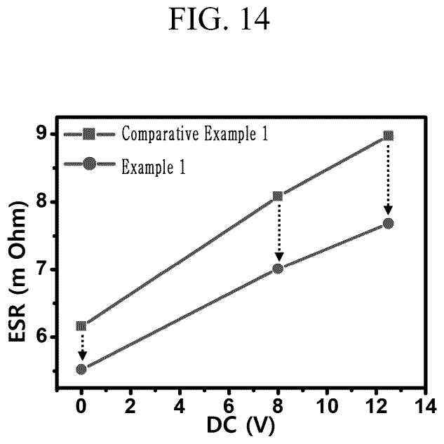

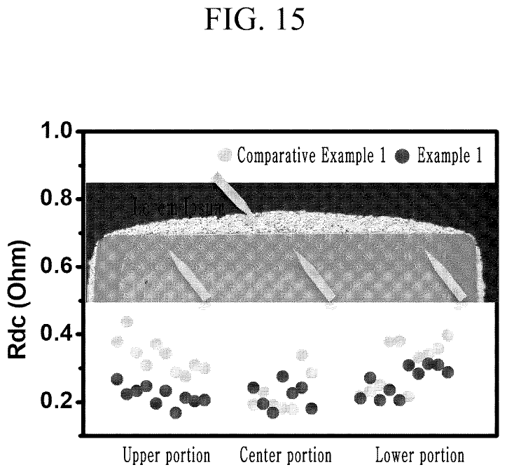

The multilayer ceramic capacitors according to Example 1 and Comparative Example 1 were measured with respect to equivalent series resistance (ESR) and DC resistance (Rdc), and the results are shown in FIGS. 14 and 15.

The equivalent series resistance (ESR) and the DC resistance (Rdc) were measured under a condition of 1 Mhz.

FIG. 14 is a graph showing the equivalent series resistance (ESR) of the multilayer ceramic capacitors according to Comparative Example 1 and Example 1, and FIG. 15 is a graph showing the DC resistance (Rdc) of the multilayer ceramic capacitors according to Comparative Example 1 and Example 1.

Referring to FIG. 14, in the multilayer ceramic capacitor of Example 1, compared with that of Comparative Example 1, equivalent series resistance (ESR) was reduced by about 15% to 20%. In addition, referring to FIG. 15, the multilayer ceramic capacitor of Example 1 exhibited lower DC resistance (Rdc) on the upper and lower portions than that of Comparative Example 1. Accordingly, the multilayer ceramic capacitor according to an embodiment, which had the inner layer of the external electrode manufactured in the MOD method, exhibited excellent electrical characteristics.

### Evaluation 6: Moisture Resistance Reliability

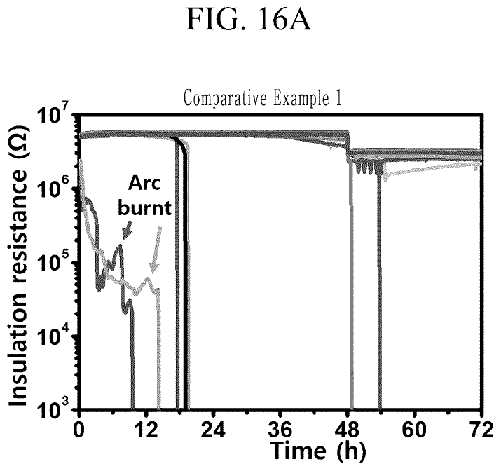

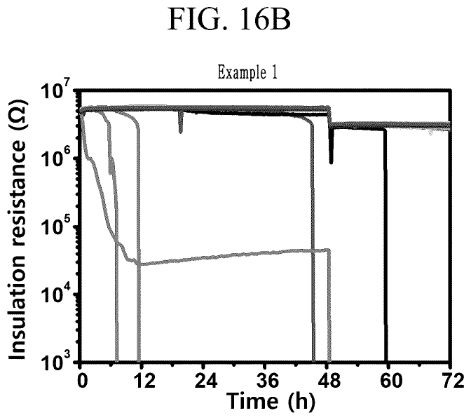

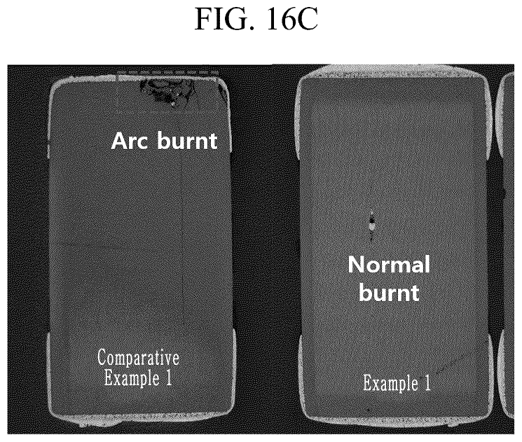

A humidity resistance harshness evaluation was performed on the multilayer ceramic capacitors manufactured in Example 1 and Comparative Example 1, and the results are shown in FIGS. 16A to 16C.

The humidity resistance harshness evaluation was measured using ESPEC (PR-3J, 8585) equipment at 85° C., 85% relative humidity (R. H.), and 24 hours.

FIG. 16A is a graph showing the moisture resistance reliability of a multilayer ceramic capacitor according to Comparative Example 1, FIG. 16B is a graph showing the moisture resistance reliability of a multilayer ceramic capacitor according to Example 1, and FIG. 16C is a photograph showing the occurrence of defects in multilayer ceramic capacitors according to Comparative Example 1 and Example 1.

Referring to FIGS. 16A to 16C, Comparative Example 1 exhibited an arc burnt defect, which was a reliability failure mode due to connectivity deterioration between external electrode and internal electrode layer, but Example 1 exhibited no arc burnt defect. Accordingly, the multilayer ceramic capacitor manufactured in Example 1 according to some embodiments of the present disclosure had the inner layer of the external electrode formed in the MOD method, thereby improving connectivity between external electrode and internal electrode layer and thus exhibiting excellent moisture resistance reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: multilayer ceramic capacitor
110: capacitor body
111: dielectric layer
121: first internal electrode layer
122: second internal electrode layer
131: first external electrode
132: second external electrode
10: first inner layer
20: first outer layer
30: second inner layer
40: second outer layer

What is claimed is:

1. A multilayer ceramic capacitor, comprising
a capacitor body including a plurality of dielectric layers and a plurality of internal electrode layers stacked with the dielectric layers interposed therebetween; and
an external electrode disposed on an outer surface of the capacitor body,
wherein the capacitor body includes an active region in which the dielectric layers and the internal electrode layers are alternately disposed, and a cover region in which the dielectric layers are disposed on the upper and lower surfaces of the active region in a stacking direction,
the external electrode includes an inner layer disposed on a surface of the active region and connected to the internal electrode layer, and an outer layer covering the inner layer,
the inner layer includes a first conductive metal and first glass, and
an area occupied by the first glass is greater than 0% and less than or equal to 6% of a total area of the inner layer.

2. The multilayer ceramic capacitor of claim 1, wherein
the first glass of the inner layer is included in an amount of greater than 0 wt % and less than or equal to 5 wt % based on a total amount of the inner layer.

3. The multilayer ceramic capacitor of claim 1, wherein
the first conductive metal of the inner layer is included in an amount of greater than 95 wt % and less than 100 wt % based on a total amount of the inner layer.

4. The multilayer ceramic capacitor of claim 1, wherein
the first conductive metal of the inner layer includes at least one selected from the group consisting of copper (Cu), nickel (Ni), silver (Ag), palladium (Pd), gold (Au), platinum (Pt), tin (Sn), tungsten (W), titanium (Ti), lead (Pb), and an alloy thereof.

5. The multilayer ceramic capacitor of claim 1, wherein
the first conductive metal of the inner layer includes copper (Cu) and nickel (Ni).

6. The multilayer ceramic capacitor of claim 1, wherein
the first glass of the inner layer includes at least one selected from the group consisting of aluminum oxide (Al₂O₃), silicon dioxide (SiO₂), lithium oxide (Li₂O), sodium oxide (Na₂O), iron (III) oxide (Fe₂O₃), zinc oxide (ZnO), barium oxide (BaO), calcium oxide (CaO), boron trioxide (B₂O₃), and tin (IV) oxide (SnO₂).

7. The multilayer ceramic capacitor of claim 1, wherein
the inner layer extends into an interior of the capacitor body and is connected to the internal electrode layer.

8. The multilayer ceramic capacitor of claim 1, wherein
the multilayer ceramic capacitor includes a Cu—Ni alloy at an interface between the inner layer of the external electrode and the internal electrode layer.

9. The multilayer ceramic capacitor of claim 1, wherein
The first glass of the inner layer is present on a surface of the dielectric layer of the active region.

10. The multilayer ceramic capacitor of claim 1, wherein a thickness of the inner layer is in a range from 1 μm to 5 μm.

11. The multilayer ceramic capacitor of claim 1, wherein
a grain size of the first conductive metal of the inner layer is from 0.5 μm to 1 μm.

12. The multilayer ceramic capacitor of claim 1, wherein
the outer layer includes a second conductive metal and second glass,
the second conductive metal of the outer layer is the same as or different from the first conductive metal of the inner layer, and
the second glass of the outer layer is the same as or different from the first glass of the inner layer.

13. The multilayer ceramic capacitor of claim 12, wherein
the outer layer includes 70 wt % to 90 wt % of the second conductive metal and 10 wt % to 30 wt % of the second glass.

14. The multilayer ceramic capacitor of claim 1, wherein the internal electrode layer includes nickel (Ni) and copper (Cu).

15. A method of manufacturing a multilayer ceramic capacitor, comprising
applying and reducing a metal-organic decomposition (MOD) ink to a surface of a capacitor body including a plurality of dielectric layers and a plurality of internal electrode layers stacked with the dielectric layers interposed therebetween to form a metal particle film for an inner layer;
applying a paste including a conductive metal and a glass composition to a surface of the capacitor body on which the metal particle film is formed to form an outer layer; and
firing the paste to form an external electrode including the inner layer formed from the metal particle film and the outer layer covering the inner layer and formed from the paste,
wherein the inner layer includes a conductive metal and glass, and
an area occupied by the glass is greater than 0% and less than or equal to 6% of a total area of the inner layer.

16. The method of claim 15, wherein
the metal-organic decomposition (MOD) ink includes a metal ligand material, an amine compound, a binder, an antioxidant, and a solvent.

17. The method of claim 15, wherein
the applying of the metal-organic decomposition (MOD) ink is performed to a thickness of 50 μm to 400 μm.

18. The method of claim 15, wherein
the reducing is performed at a temperature of 170° C. to 300° C. for 30 minutes to 3 hours.

19. The method of claim 15, wherein
the metal particle film includes metal nanoparticles of 10 nm to 50 nm.

20. The method of claim 15, wherein
the glass composition is included in an amount of 10 wt % to 30 wt % based on a total amount of the paste.
